(19) United States
(12) Patent Application Publication
(10) Pub. No.: US 2004/0023096 A1
(43) Pub. Date: Feb. 5, 2004

(54) Fuel cell system having a filter element for purifying ambient environmental air

(76) Inventors: Steven Duane Pratt, Ft. Lauderdale, FL (US); Sivakumar Muthuswamy, Plantation, FL (US); Ronald J. Kelley, Coral Springs, FL (US); Robert W. Pennisi, Boca Raton, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 10/209,231

(22) Filed: Jul. 31, 2002

(51) Int. Cl. H01M 8/04

(52) U.S. Cl. 429/34

(57) ABSTRACT

An air-breathing fuel cell device (100) has an integral filter system (160) for removing pollutants and contaminants. The fuel cell device (100) has a membrane electrode assembly (140) captured by a housing (101) that has an inlet (102) for receiving ambient environmental air. The filter assembly (160) is captured by the housing (101), and is interposed between the membrane electrode assembly (140) and the inlet (102) such that the membrane electrode assembly (140) is exposed to purified air through the filter assembly (160), and is otherwise sealed from the ambient environmental air.

### TECHNICAL FIELD

This invention relates in general to fuel cells, and more particularly to fuel cells that use ambient environmental air as an oxidant supply.

### BACKGROUND

Fuel cells are electrochemical cells in which a free energy change resulting from an oxidation reaction is converted into electrical energy. A typical fuel cell consists of a fuel electrode (anode) and an oxidant electrode (cathode), separated by an ion-conducting electrolyte. The electrodes are connected electrically to a load (such as an electronic circuit) by an external circuit conductor. In the circuit conductor, electric current is transported by the flow of electrons, whereas in the electrolyte it is transported by the flow of ions, such as the hydrogen ion (H+) in acid electrolytes, or the hydroxyl ion (OH−) in alkaline electrolytes. A fuel capable of chemical oxidation is supplied to the anode and ionizes on a suitable catalyst to produce ions and electrons. Gaseous hydrogen is the fuel of choice for most applications, because of its high reactivity in the presence of suitable catalysts and because of its high energy density. Similarly, an oxidant is supplied to the fuel cell cathode and is catalytically reduced. The most common oxidant is gaseous oxygen, which is readily and economically available from the air for fuel cells used in terrestrial applications. When gaseous hydrogen and oxygen are used as a fuel and oxidant, the electrodes are porous to permit the gas-electrolyte junction to be as great as possible. The electrodes must be electronic conductors, and possess the appropriate reactivity to give significant reaction rates. Since the electrolyte is a non-electronic conductor, the electrons flow away from the anode via the external circuit. At the cathode, oxygen reacts with the hydrogen ions migrating through the electrolyte and the incoming electrons from the external circuit to produce water as a byproduct. The byproduct water is typically extracted as vapor. The overall reaction that takes place in the fuel cell is the sum of the anode and cathode reactions, with part of the free energy of reaction released directly as electrical energy and the remainder as heat.

In recent years, portable electronic devices have been reduced in size and made lightweight. At the same time, energy hungry features such as full color displays, multimedia applications, large bandwidth data transmission applications, and ‘always on, always connected’ applications, have pushed traditional electrolytic battery technology to the limits. Some have sought to replace electrolytic batteries with small fuel cells. The tremendous advantage of fuel cells is the potential ability to provide significantly larger amounts of energy in a small package (as compared to a battery). However, prior art small fuel cell systems in operation are either closed systems, in which the oxidant supply is stored onboard in a pressurized vessel and provided in a controlled fashion, or open (air-breathing) systems designed to operate only in controlled environments such as in air-conditioned laboratories or homes. Neither of the above two systems is appropriate as a battery replacement, the first being too large and complex of a system, and the second having too limited of an operating environment.

The promise of fuel cells as replacement for small portable devices have yet to be realized because, among other issues, current configurations do not lend themselves for robust operation in various environment. Therefore, there would be advancement in the art to have fuel cell systems capable of operating under a wide range of environmental conditions.

### BRIEF DESCRIPTION OF THE DRAWINGS

FIG. 1 is a cross-sectional view of a fuel cell device incorporating a system for removing impurities from an oxidant air supply, in accordance with the invention.

FIG. 2 is a cut-away view of an electronic device incorporating the fuel cell device of FIG. 1, in accordance with the invention.

### DETAILED DESCRIPTION OF THE PREFERRED EMBODIMENT

While the specification concludes with claims defining the features of the invention that are regarded as novel, it is believed that the construction, method of operation and advantages of the invention will be better understood from a consideration with the drawing figure.

Generally, the present invention provides for an air-breathing fuel cell device with an integral filter system for removing pollutants and contaminants. The fuel cell device has a membrane electrode assembly (MEA) captured by a housing that has an inlet for receiving ambient environmental air. A filter assembly, also captured by the housing, is interposed between the MEA and the inlet such that an enclosed air-breathing fuel cell is exposed to purified air through the filter assembly, and is otherwise sealed from the ambient environmental air. Preferably, the air-breathing fuel cell device is portable, having a volume of at most 500 cubic centimeters, and utilizes non-forced ambient environmental air as an oxidant source, i.e., there is no use of a fan, blower, pump or other means of forcing air onto or into the fuel cell.

Common pollutants and contaminants such as carbon monoxide (CO), nitrogen oxides (NOₓ), ozone (O₃), lead (Pb), sulfur oxides (SOₓ), toxic emissions of hazardous air pollutants (HAP), and particulate matter (PM), have been found to adversely affect air-breathing fuel cells. Carbon monoxide (CO) is formed in the environmental air by incomplete combustion of carbon containing fuels. Local accumulation in heavy traffic is a primary source of CO pollution. Other sources include industrial processes and fuel combustion in boilers and incinerators. Recent Environmental Protection Agency (EPA) data obtained through the Aerometric Information Retrieval System (AIRS) found peak community exposures to be generally 15-25 parts per million (ppm) for an eight-hour average and 25-35 ppm for one-hour averages. Nitrogen oxides NOₓ are a family of highly reactive gases that are formed when fossil fuels are burned at high temperatures. Fossil fuel combustion generates nitrogen dioxide (NO₂) and nitric oxide (NO), which is rapidly oxidized to NO₂. Principle sources of NOₓ pollution are motor vehicle exhaust and stationary sources such as electric utilities and industrial boilers. Indoor exposure to NO₂ can be substantial from unvented combustion sources, such as gas stoves and space heaters. A suffocating, brownish gas, NO₂ is a strong oxidizing agent that reacts in the air to form corrosive nitric acid, as well as toxic organic nitrates. NO₂ also reacts in the presence of sunlight and volatile organic compounds (VOC) to produce ground level ozone (O₃). EPA data reports peak one-hour exposure levels of over 0.2 ppm. Ground level ozone (O₃) is the primary constituent of smog. Unlike other air pollutants, O₃ is not emitted directly into the air by specific sources. Ambient O₃ concentrations rise as a result of solar ultraviolet irradiation driven by a complex series of reactions involving VOC and NOx. Recent EPA data shows typical peak community levels at 0.10-0.18 ppm with rare exposures as high as 0.37 ppm. Lead (Pb) air pollution stems mainly from smelters, battery plants and the combustion of leaded fuels. The highest concentrations of lead are found in the vicinity of nonferrous smelters and other stationary sources of lead emissions. Peak lead concentrations range from 0.12 ppm to 0.40 ppm. Sulfur oxides (SOₓ) are a family of gasses that are formed during the combustion of sulfur-containing fossil fuels such as coal and oil, during metal smelting, paper manufacturing, food preparation and other industrial processes. Sulfur dioxide (SO₂) is an important contributor to acid aerosols and “acid rain”, and is typically a component of complex pollutant mixtures. Peak one-hour SO₂ values recently reported by the EPA occur in the 0.4 ppm to 0.8 ppm range, with rare higher excursions. Particulate matter (PM) is the term for solid or liquid particles found in the air. Because the particles originate from a variety of mobile and stationary sources their chemical and physical compositions vary wildly. Contributing species include sulfur oxides, metals, nitric acid, ammonium salts, acid aerosols, mechanically generated dusts (silica, etc), some with adherent polycyclic aromatic hydrocarbons, dioxins, dibenzorurans, etc, and are usually present as a complex mixture with atmospheric reaction byproducts. Particulate matter with particle diameters of 10 micrometers or less (PM₁₀) average peak levels of 35 □g/m³ to 55 □g/m³. Common particulates include benzene, 1,3-butadiene, formaldehyde, styrene, polycyclic aromatic compounds, mutagenic heterocyclic amines, polychlorinated dibenzodioxins and polychlorinated dibenzofurans, tetrachloroethylene (perchloroethylene), and the like.

The contaminants present in environmental air pollution can damage a fuel cell by aggressively attacking the platinum catalyst at the cathode electrode and by degrading the polymer electrolyte membrane. Present day fuel cell systems operating in polluted environments either require an onboard supply of clean oxidant or they have a limited life due to contamination, thus excluding such fuel cell systems as battery replacements for practical use in portable electronic equipment.

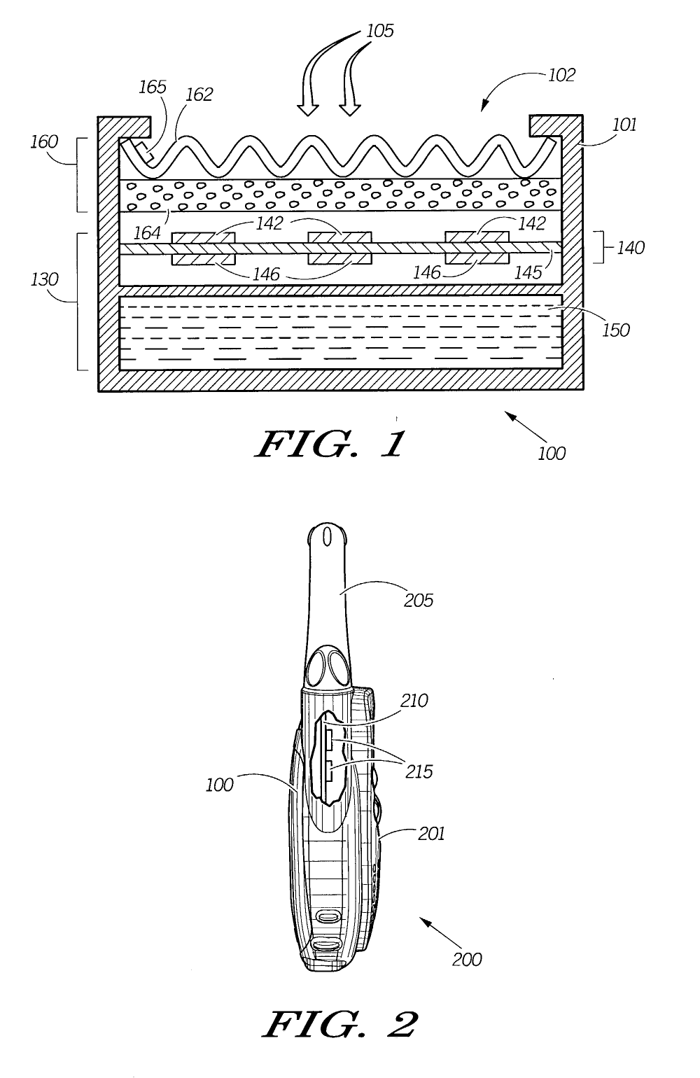

FIG. 1 shows a portable fuel cell device 100, in accordance with the present invention. The device 100 has a housing 101 that captures an air-breathing fuel cell 130. In the preferred embodiment, the housing 101 has a volume of at most 500 cubic centimeters, which facilitates portability. The fuel cell 130 includes a membrane electrode assembly (MEA) 140 and a fuel reservoir 150 containing fuel. The MEA of the preferred embodiment has a planar membrane structure 145 having cathodes 142 and anodes 146 disposed on opposing sides of the structure. The fuel cell operates when the anodes 146 are exposed to fuel and the cathodes exposed to an oxidant stream. The oxidant stream is sourced from ambient environmental air through an air inlet 102 within the housing 101. However, as described earlier, air usually contains trace amounts of gaseous contaminants and particulate impurities that are harmful to the fuel cell or detrimental to the fuel cell performance. Accordingly, the fuel cell device 100 includes a filter assembly 160 that is interposed between the air-breathing fuel cell 130 and the air inlet 102 for providing purified air to the cathode. The filter assembly 160 is positioned such that the cathodes 142 are exposed to ambient environmental air 105 through the filter assembly 160, and are otherwise sealed from the ambient environmental air. The filter assembly 160 is preferably capable of removing carbon monoxide (CO), nitrogen oxides (NOₓ), ozone (O₃), lead (Pb), sulfur oxides (SOₓ), toxic emissions of hazardous air pollutants (HAP) and particulate matter (PM) from the air supply 105. In one aspect of the invention, the filter assembly 160 is removably disposed within the housing so that the filter is user replaceable. The term ‘removably disposed’ signifies that the filter 160 and the fuel cell 130 are separable and are not permanently joined together, nor are they a monolithic one piece unit. Preferably, the filter 160 is attached to the fuel cell housing 101 in such a way that it can be easily and quickly separated from the fuel cell 130 without the use of tools. The filter element 160 may be mechanically attached to the fuel cell housing 101 by a snap fit or other conventional latch mechanisms, or it may be screwed on, or sealed in place.

In the preferred embodiment, the filter assembly 160 is a two-stage filter having a particulate stage 162 and a chemically active stage 164. The particulate filter stage 162 is a high efficiency particulate arresting structure formed from an intricate web of micro-fibers and designed to capture and trap sub-micron size particles. This fiber filter 162 is pleated to provide a very large surface area so that a substantial amount of air can move through the filter.

The chemically active filter stage 164 is comprised of a substance that binds gases on its surface. Active gases are chemisorbed and/or physisorbed onto the surface, while other gases pass by unaffected. Chemisorption is a well-known chemical adsorption process in which weak chemical bonds are formed between gas or liquid molecules and a solid surface. Chemically active filters are commonly used to remove contaminants from gases, and are differentiated from particulate filters. Rather than ‘filtering’ contaminants by mechanical size exclusion principles, chemically active filters tend to adsorb impurities. The chemically active filter stage 164 chemisorbs the impurities from the oxidant stream 105. Materials suitable for the chemically active filter stage of the present invention include platinum, silver, tungsten, glass powder, mica, charcoal, iron and iron compounds. In the preferred embodiment, the chemically active filter stage 164 is comprised of an activated carbon mat. The filter assembly 160 preferably includes a visual indication means 165 that communicates to the user when it has reached its capacity and is exhausted, used up, clogged, filled, depleted, expired, consumed or spent, and needs to be replaced. Several methods of monitoring or measuring the remaining capacity of the filter element are known in the industry, such as incorporating materials that change color to indicate the amount of contaminants taken up, electronic gauges, measuring and comparing the amount of impurities in the incoming stream versus the ‘purified’ stream, etc.

In operation, ambient environmental air passes through the filter 160 and purified or clean air presented to the fuel cell 130. Clean or purified air preferably has the following pollution-component concentrations: Carbon Monoxide (CO), less than 8 ppm (8.9 mg/m³); Nitrogen Dioxide (NO₂), less than 0.05 ppm (94 □g/m³); Ozone (O₃), less than 0.08 ppm (157 □g/m³); Lead (Pb), less than 0.05 ppm (424 □g/m³); Sulfur Dioxide (SO₂), less than 0.03 ppm (80 □g/m³); Particulate Matter (PM₁₀), less than 25 □g/m³.

FIG. 2 shows a fuel cell powered electronic device 200, in accordance with the present invention. The device 200 of the preferred embodiment is a radio communication device, such as a mobile telephone, that communicates over radio frequency channels. Accordingly, the device 200 has a housing 201 that captures an antenna for receiving and transmitting radio frequency signals, and a circuit substrate sub-assembly 210 having electronics 215 for processing the radio frequency signals. The device 200 incorporates the fuel cell device 100 described earlier, which provides power to the device electronics 215. The fuel cell powered electronic device 200 of the preferred embodiment is portable and has a total volume not exceeding 500 cubic centimeters.

By utilizing the present invention, ambient environmental air can be used as the oxidant supply in a portable fuel cell application. The replaceable filter 160 element eliminates the need for a more elaborate, larger and heavier onboard oxidant supply storage and distribution system by allowing (polluted) ambient environmental air as the oxidant supply, and, hence, allowing for portable air-breathing fuel cell systems of practical size, cost and operating environment.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A fuel cell having an inlet for receiving ambient environmental air, comprising:
a membrane electrode assembly, comprising:
a membrane structure having first and second sides opposing each other;
an anode disposed on the first side of the membrane structure;
a cathode disposed on the second side of the membrane structure;
a filter assembly interposed between the cathode and the inlet;
wherein the cathode is exposed to the ambient environmental air through the filter assembly, and is otherwise sealed from the ambient environmental air.

2. The fuel cell of claim 2, wherein the filter assembly comprises a particulate filter stage.

3. The fuel cell of claim 2, wherein the particulate filter stage is a high efficiency particulate arresting (BEPA) structure.

4. The fuel cell of claim 2, wherein the filter assembly comprises a chemically active filter stage.

5. The fuel cell of claim 2, wherein the chemically active filter stage comprises activated carbon.

6. The fuel cell of claim 2, wherein the filter assembly comprises a chemically active filter stage and a particulate filter stage.

7. A fuel cell device, comprising:
a housing having an inlet for receiving non-forced ambient environmental air;
an air-breathing fuel cell captured by the housing;
a filter assembly captured by the housing and interposed between the air-breathing fuel cell and the inlet;
wherein the air-breathing fuel cell is exposed to purified air through the filter assembly, and is otherwise sealed from the ambient environmental air.

8. The fuel cell device of claim 7, wherein the filter assembly comprises a particulate filter stage.

9. The fuel cell of claim 7, wherein the filter assembly comprises a chemically active filter stage.

10. The fuel cell of claim 7, wherein the filter assembly comprises a chemically active filter stage and a particulate filter stage.

11. The fuel cell of claim 7, wherein the air-breathing fuel cell is a planar fuel cell.

12. The fuel cell of claim 7, wherein the housing has a volume of at most 500 cubic centimeters.

13. A portable electronic device, comprising:
a housing;
a sub-assembly carried by the housing, the sub-assembly having electronic components;
an air-breathing fuel cell carried by the housing, and coupled to the sub-assembly, the air-breathing fuel cell comprising:
an inlet for receiving ambient environmental air;
a membrane electrode assembly, comprising a membrane structure having at east one anode and at least one cathode;
a filter assembly interposed between the inlet and the at least one cathode;
wherein the at least one cathode is exposed to purified air through the filter assembly, and is otherwise sealed from the ambient environmental air.

14. The device of claim 13, wherein the filter assembly comprises a particulate filter stage.

15. The device of claim 13, wherein the filter assembly comprises a chemically active filter stage.

16. The fuel cell of claim 13, wherein the filter assembly comprises a chemically active filter stage and a particulate filter stage.

17. The fuel cell of claim 13, wherein the housing has a volume of at most 500 cubic centimeters.

18. A system for removing impurities from an oxidant supply stream for a fuel cell, comprising a filter element for removing the impurities from the oxidant supply stream, the filter element being removably disposed between the oxidant supply stream and a cathode side of the fuel cell so as to be replaceable by a human user of the fuel cell.

19. The system of claim 18, wherein the filter element further comprises a particulate filter stage and a chemically active filter stage.

20. A method of operating a fuel cell, comprising:
providing an air stream to the fuel cell; and
filtering the air stream supply through a filter element having a chemically active stage and a particulate removal stage.
